(19) United States
(12) Patent Application Publication
(10) Pub. No.: US 2025/0303641 A1
(43) Pub. Date: Oct. 2, 2025

(54) GRAPE DATA FORMAT AND METHOD OF 3D PRINTING

(71) Applicant: Copner Biotech Ltd, Abergavenny (GB)

(72) Inventors: Jordan C. COPNER, Abergavenny, Monmouthshire (GB); Alan J. COPNER, Abergavenny, Monmouthshire (GB)

(21) Appl. No.: 18/863,975

(22) PCT Filed: Apr. 4, 2023
(86) PCT No.: PCT/GB2023/050890

§ 371 Date: Nov. 7, 2024

(30) Foreign Application Priority Data
May 9, 2022 (GB) 2206781.3
Aug. 1, 2022 (GB) 2211174.4

(51) Int. Cl. B29C 64/393; B29C 64/112; B29C 64/209; B29C 64/321; B29K 105/00; B33Y 30/00; B33Y 50/02

(52) U.S. Cl. CPC B29C 64/393; B29C 64/112; B29C 64/209; B29C 64/321; B33Y 30/00; B33Y 50/02; B29K 2105/0094

(57) ABSTRACT

Disclosed is a method for preparing a data set for a construct to be printed in layers. the method comprising using a computer program to carry out the steps of: a) defining in a two-dimensional plane a layer of the construct in terms of one or more polygonal primitives: b) for each primitive defining a set of first and second coordinates in the two dimensions representing corner points of the or each primitive: c) defining a common third coordinate based on the thickness of the or each primitive perpendicular to the two-dimensional plane: and d) forming a data set based on the first second and third coordinates. The data set can be manipulated further to produce start and stop points for printing. The data set can describe a 3D printable object with significantly less data than a conventional STL data file. The invention extends to improved modes of dispensing print material including droplet dispensing while a printhead is stationary. and 3D printing apparatus for said improved dispensing.

This application is a U.S. National Stage Application under 35 U.S.C § 371 of International Patent Application No. PCT/GB2023/050890 filed Apr. 4, 2023, which claims the benefit of priority to Great Britain Patent Application Nos. 2206781.3 filed May 9, 2022, and 2211174.4 filed Aug. 1, 2022 the disclosures of all of which are hereby incorporated by reference in their entirety.

The invention relates to a method to define printable 3D model construct(s) to a high degree of accuracy, using a data format given the acronym GRAPE (Graphical Rectangular Actual Positional Encoding) whereby the 3D printed model construct generated by the data set will be an assembly of straight sided polygons, referred to herein as rectangles or rectangular forms for convenience, printed to produce a desired model construct.

Typically, Standard Tessellation Language (STL) data file formats describe the surface geometry of a three-dimensional object. The STL format usually specifies ASCII or binary representations. Binary files are more common, since they are more compact, but still the amount of data needed to define a construct becomes very large for complex shapes.

Realising the shortcomings of the STL data format; the inventors devised an alternative approach to driving a 3D printer based on 3D model constructed from straight line geometric forms in the shape of solid polygonal primitives, preferably rectangular primitives, as two-dimensional forms. This makes the 3D print instructions much simpler, and therefore quicker to load and run, leading to quicker and more accurate 3D printing.

In particular, the only data required to define and print a 3D model formed from the GRAPE rectangular forms is the two dimensional (e.g., X & Y axis) positional coordinates of the four corners of the rectangular form together with its thickness.

This new data format has been given the acronym Graphical Rectangular Actual Positional Encoding (GRAPE) because those positional coordinates provide all the information required to determine the size and orientation of the rectangular forms as well as being able to recreate the rectangular construct in STL data format. Models defined in GRAPE data format are stored to files having a file extension of .cbl.

The invention extends also to the methodology of printing previously problematic materials, for example, to augment the above-mentioned data format. In particular, the invention includes, according to a first technique, a printing mode for continuous spraying of a low viscosity material while a dispensing part moves relative to a bed of a printing machine or a previously printed feature printed part, or, according to a second technique, a printing mode for extrusion of a droplet of a viscous, or semi-viscous, material whilst a dispensing part is substantially stationary at a first location, the dispensing part moving relative to the bed or a previously extruded feature, to a second location adjacent the first location, only once the droplet dispensed at the first location touches either the bed or the previously extruded feature. In this way an accurate reproduction of the print data can be obtained, and, if the above mentioned first or second mode is selectable, then printing technique can be made adaptable to suit the viscosity of the material to be dispensed.

In order to facilitate the printing of problematic materials the inventors have derived a flexible method of allowing operators to both define ‘recipes’ and ‘material delivery configurations’ which are converted into a file using Extensible Markup Language (xml) that is then employed by the control software to print the required 3D model.

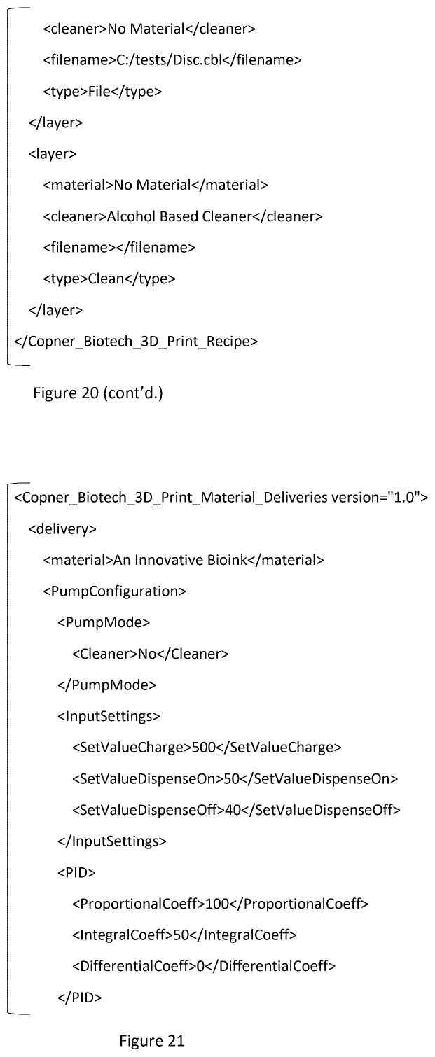

Recipes (for example as defined in FIG. 20) enable operators to define a 3D model printing process. Recipes can consist of any combination of printing/clean/charge steps as required to print the model in a layer by layer fashion; with each recipe step having an associated material. Recipes consist of one or more steps; which are processed by the control software in sequential manner beginning at the first step in the recipe.

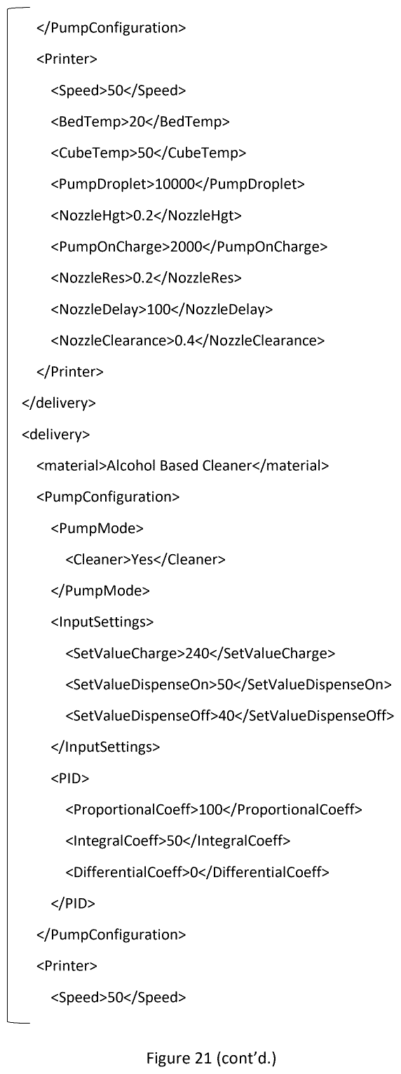

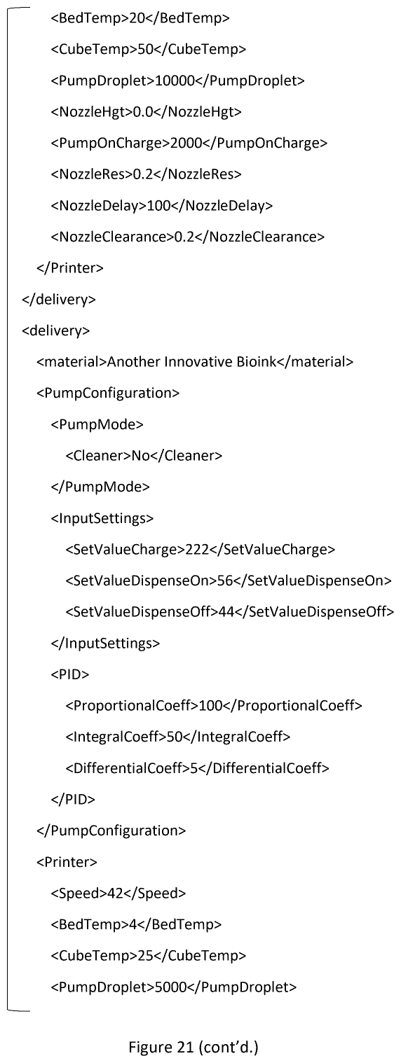

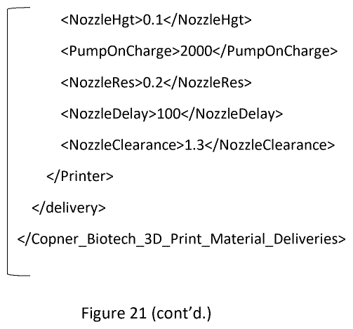

Material delivery configurations as defined in FIG. 21 enable operators to specify optimal printing/deployment parameters for a material; which are employed by the control software as required due to material reference in the recipe step being processed.

The invention extends also to a 3D printer arranged to print materials according to the improved techniques.

The invention can be put into effect in numerous ways, examples of which are shown in the attached drawings, wherein:

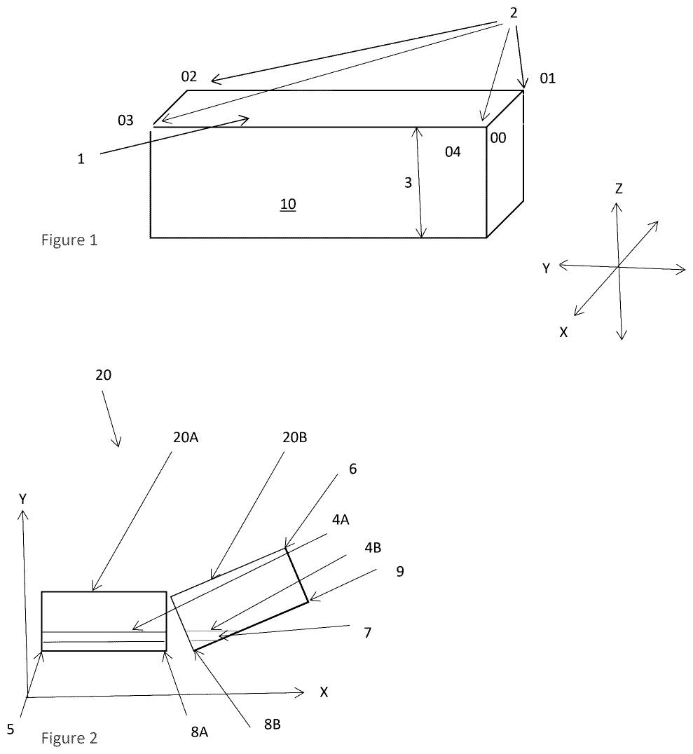

FIG. 1 is a pictorial view of a rectangular primitive form which will be defined by coordinates in the GRAPE data format;

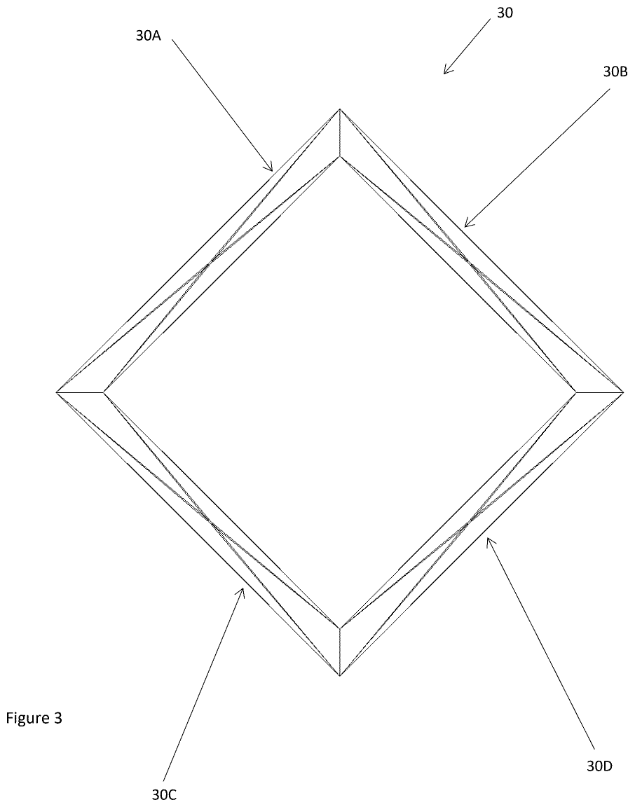

FIG. 2 is a plan view of two rectangular primitives each of which can be defined as coordinates when sliced in the Y direction;

FIG. 3 is a plan view of an example of a square frame defined by rectangles;

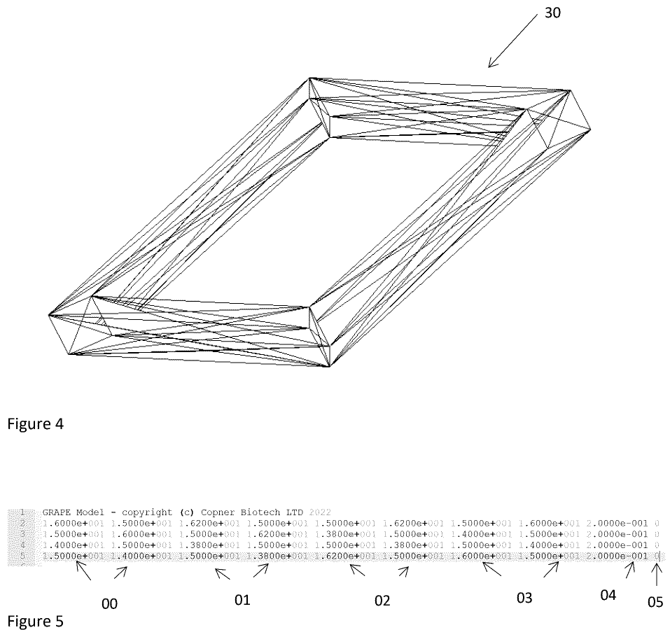

FIG. 4 is a pictorial view of the square frame shown in FIG. 3;

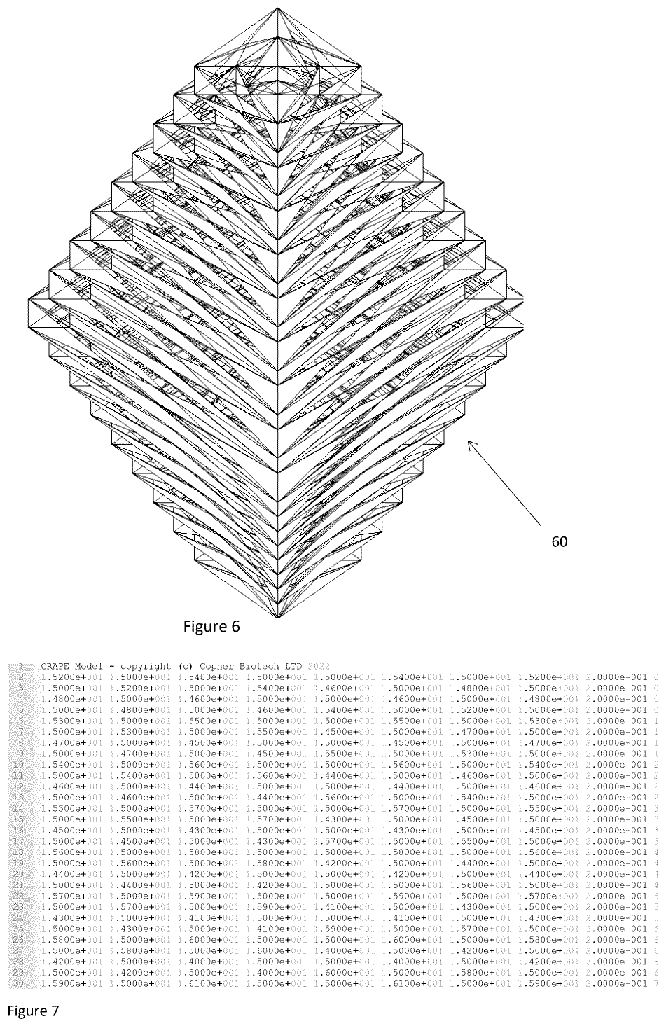

FIG. 5 is an example data set required according to the invention to define the frame shown in FIGS. 3 and 4;

FIG. 6 is a pictorial view of a diamond shaped construct, formed from different sized square frames of the type shown FIGS. 3 and 4.

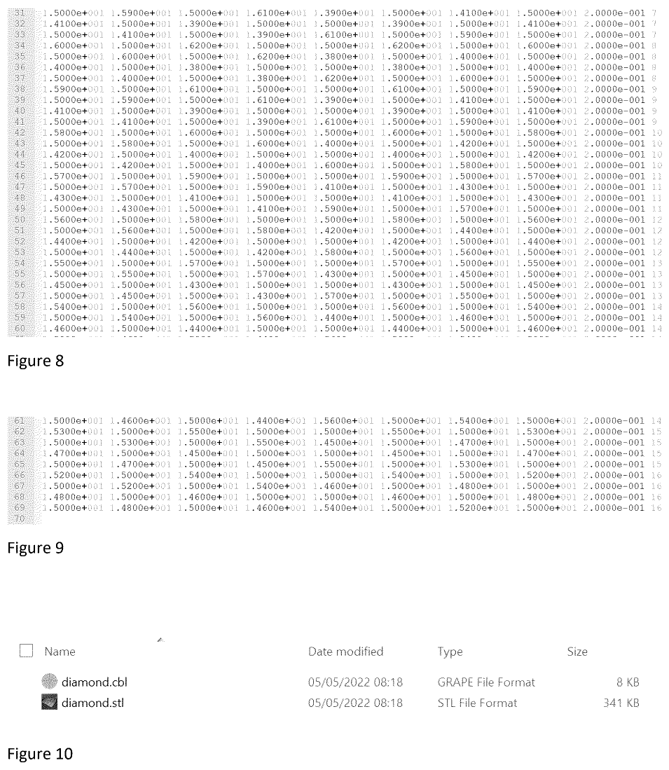

FIGS. 7, 8 and 9 are examples of the data set required according to the invention to define the diamond shape shown in FIG. 6;

FIG. 10 is a computer operating system directory screen capture showing file details for data sets in both GRAPE and STL file formats the data defining the same diamond shape shown in FIG. 6.

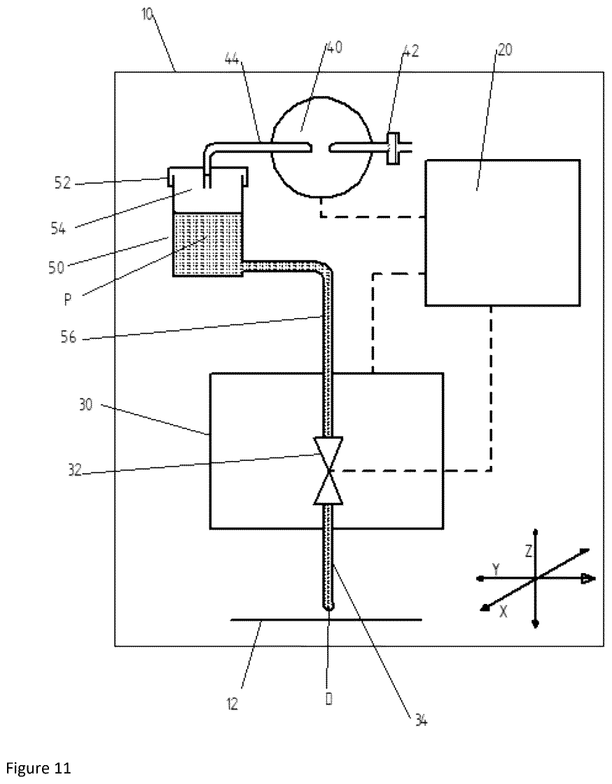

FIG. 11 shows a printer for use with the improved printing techniques described herein.

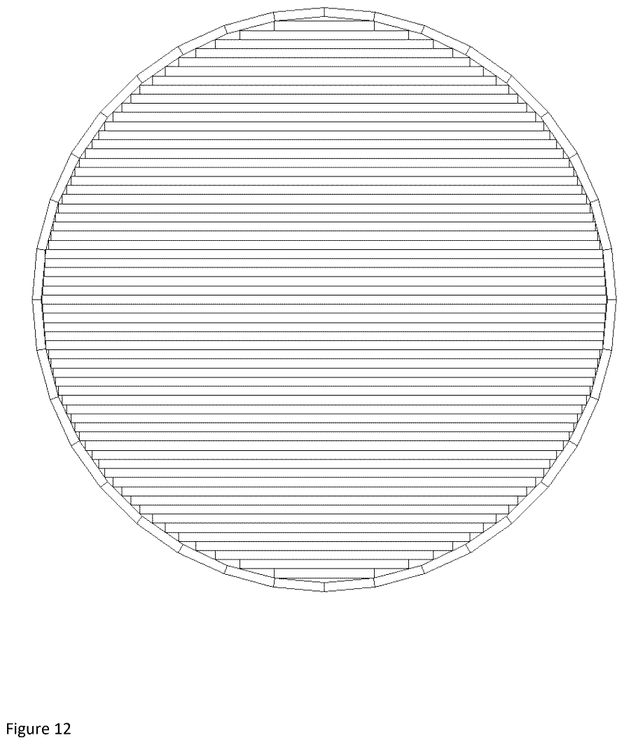

FIG. 12 shows a plan view of an example of a disc; defined using rectangles

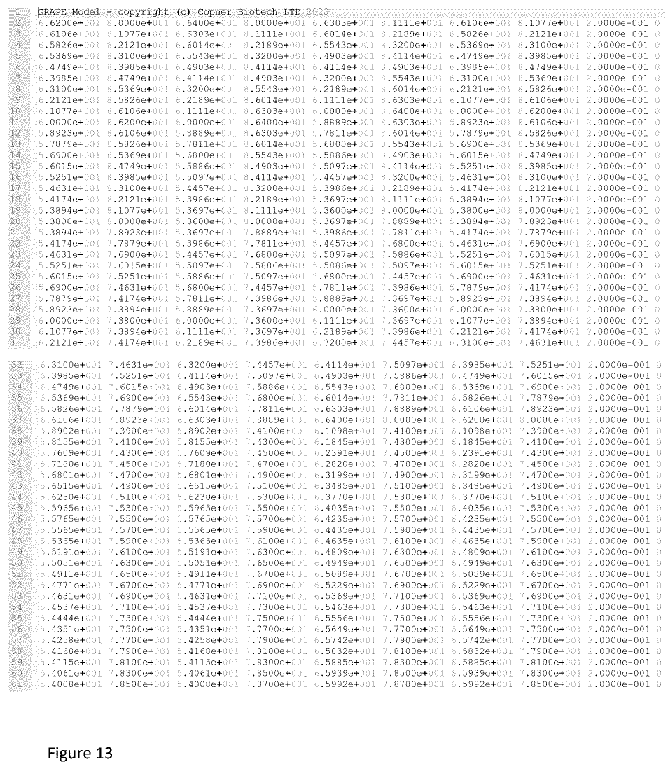

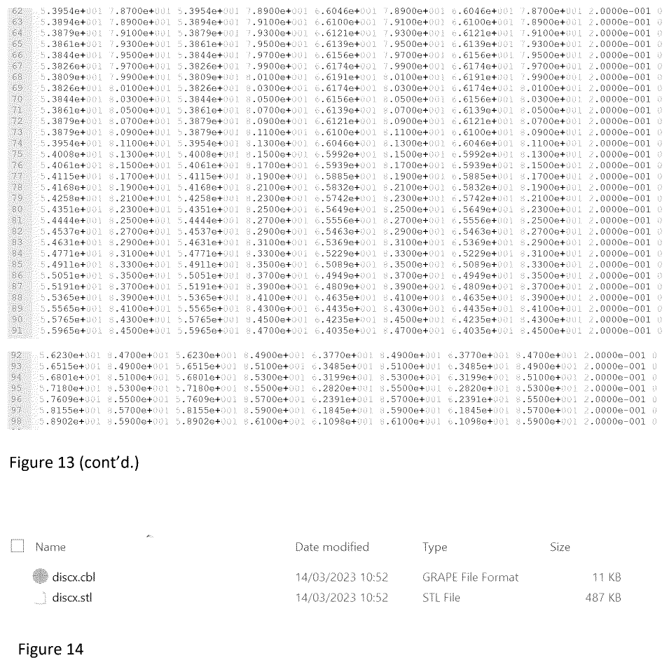

FIG. 13 is an example data set required according to the invention to define the disc shown in FIG. 12;

FIG. 14 is a computer operating system directory screen capture showing file details for data sets in both GRAPE and STL file formats the data defining the same disc shape shown in FIG. 12;

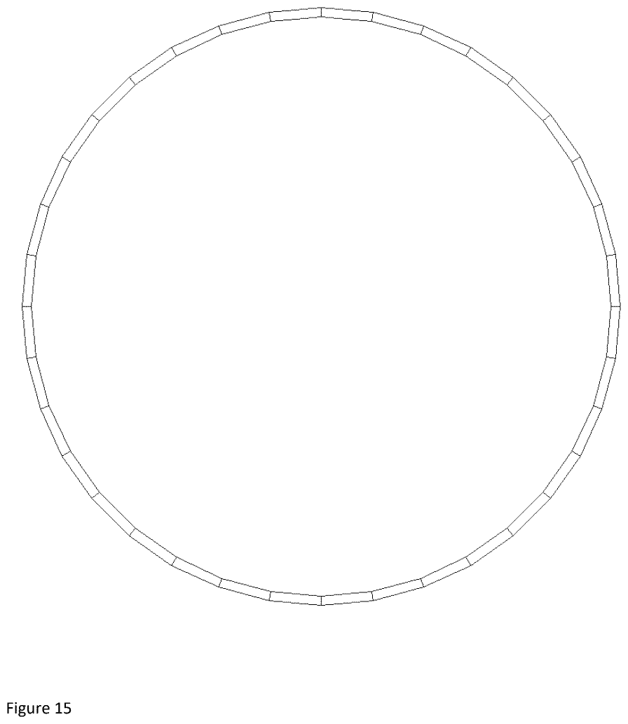

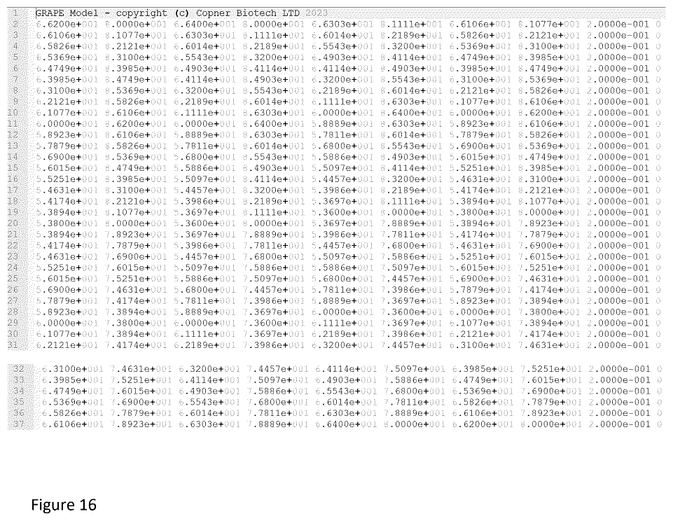

FIG. 15 shows a plan view of an example of a circle defined using rectangles;

FIG. 16 is an example data set required according to the invention to define the circle shown in FIG. 15;

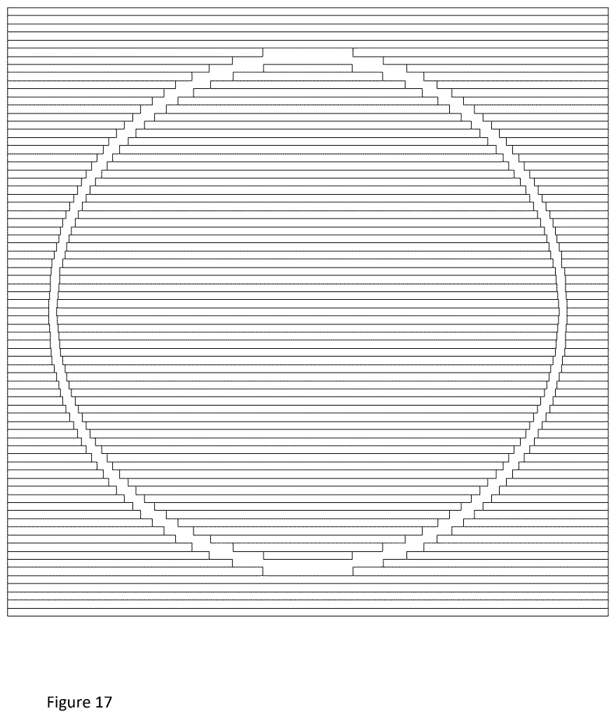

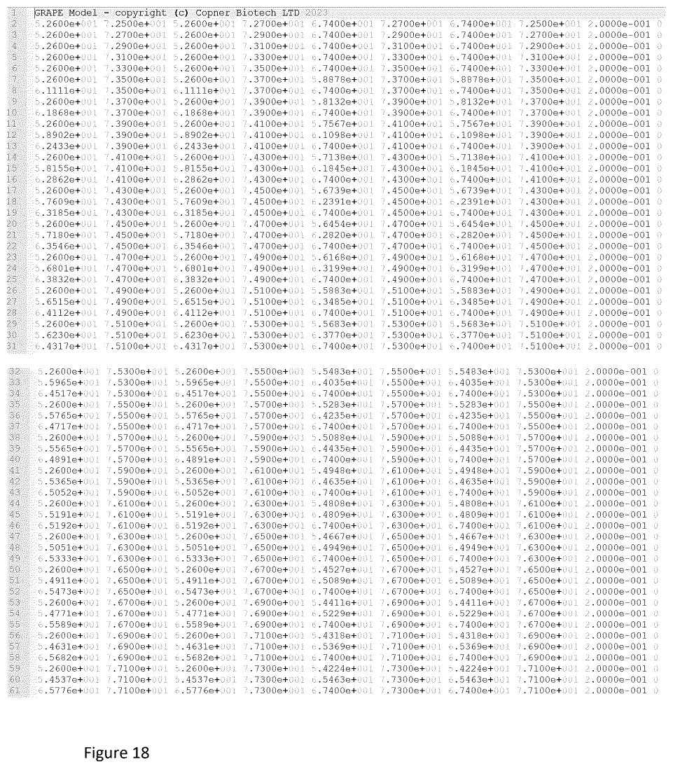

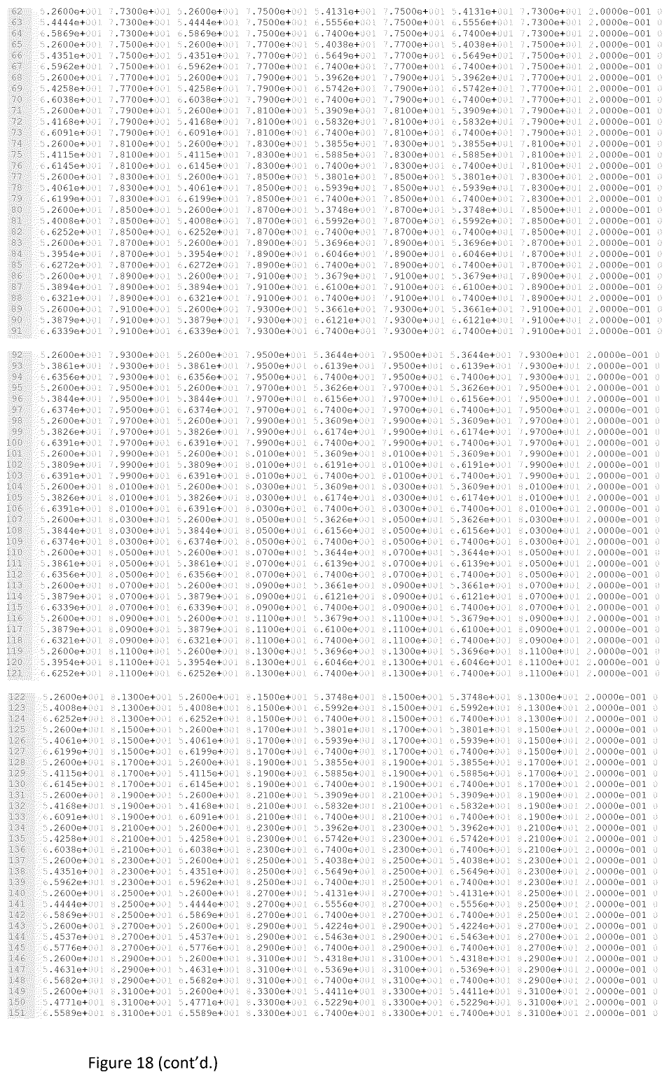

FIG. 17 shows a plan view of an example of an inverse of a circle contained withing a square defined using rectangles;

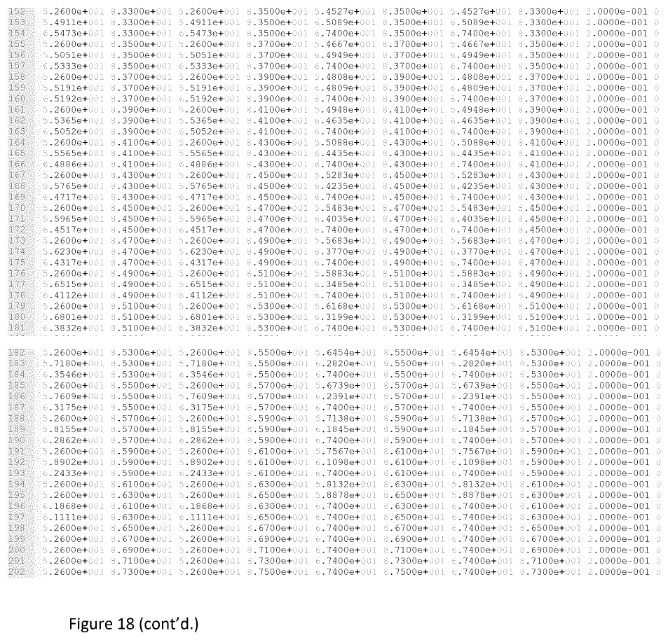

FIG. 18 is an example data set required according to the invention to define the inverse of a circle contained within a square as shown in FIG. 17;

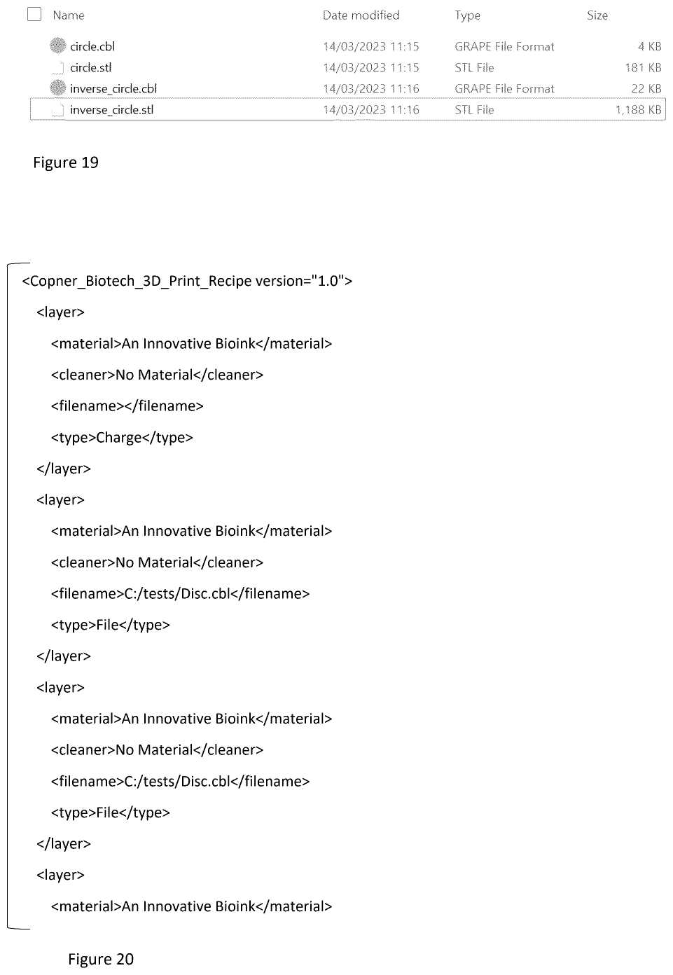

FIG. 19 is a computer operating system directory screen capture showing file details for data sets in both GRAPE and STL file formats the data defining the same circle and inverse circle contained with in a square shape shown in FIGS. 15 and 17;

FIG. 20 is a computer generated Extensible Markup Language (xml) file defining a recipe consisting of a material charge step; three model layer print steps and finally a clean step; and

FIG. 21 is a computer generated Extensible Markup Language (xml) file defining two model materials and one clean material; material delivery configurations.

FIG. 1 depicts a rectangular primitive construct 10 and identifies the Graphical Rectangular Actual Positional Encoding (GRAPE) data elements of interest, i.e., the top face of rectangular construct 1; rectangular construct XY coordinate points of the top face bounded corners 2; and rectangular construct thickness 3 i.e., the common Z coordinate.

Referring to FIG. 1, the inventors realised that the rectangular form data required to drive a printer to print a solid rectangular shape 10 can be determined from a single rectangular face (top) 1, namely the positional coordinates 2 in X and Y at each corner of the rectangle top face 1, referenced as: 00; 01; 02; and 03; together with the required rectangular construct thickness 3 being the common Z positional coordinate 04 at each rectangular corner. The Z positional coordinate of the rectangle bottom face is the base/floor Z positional value; starting at 0.0 for the first layer to be printed. The base/floor Z positional value is adjusted after printing each layer to become value of the maximum/highest Z positional coordinate of the layer just printed.

FIG. 2 depicts the decoding of GRAPE data format by the control software to positionally drive the 3D print head assembly and delivery of material. Employing GRAPE data format, the inventors have devised 3D printer control software that for each model construct layer 20, which in this case comprises a collection of rectangular constructs 20A and 20B similar to the construct 10 described above and then, referring additionally to FIG. 2; performs a type of slicing activity along an axis (e.g. the Y axis in FIG. 2 from the minimal Y plane (defined by the rectangular construct(s) having the lowest Y coordinate 5 in FIG. 2) to the maximal Y plane 6 (defined by the rectangular construct(s) having the highest Y coordinate value FIG. 2).

The control software also determines the number of layer print passes required given the print delivery resolution and required rectangular construct(s) thicknesses e.g. 3 in FIG. 1. Incremental print passes for each layer are defined, two of which 7 are shown in FIG. 2. For each incremental) Y plane layer 7 beginning at Y minimal plane 5 and ending at Y maximal plane 6 the control software:
1. Determines the extreme minimum 5 and maximum 9 X coordinates for model layer rectangular constructs 20A and 20B intersecting this Y print plane;
2. Determines the X coordinate of the boundary line entry point 5 (in this case) of the first/next model layer rectangular construct that intersects this Y plane;
3. Determines the X coordinate of the boundary line exit point 8A (in the case of the first slice) of the first/next model layer rectangular construct that intersects this Y plane;
4. Calculates the rectangular construct Y print plane slice distance between the determined entry and exit X coordinate points 4A and 4B for example;
5. Drives the printer head from the minimal/current X coordinate to the boundary line entry point X coordinate 5 of the first/next rectangular construct that intersects this Y plane with no material being dispensed;
6. Drives the printer head in the X plane from the rectangular construct X coordinate entry point 5 to the X coordinate exit point 8A whilst dispensing print material.
7. At the rectangular construct X coordinate exit point 8A the dispensing of print material is suspended; and remains suspended until the next rectangular construct on this Y print plane 8B is intersected.
8. The process of printing (steps 2 to 7) is repeated for all model layer rectangular construct(s) that the current Y print plane line intersects as previously determined by the rectangular construct having the maximum X coordinate on this Y plane (step 1).
9. The Y plane is repeatedly incremented by a configured amount of 10 to 1000 microns (material delivery resolution); with the printing process described above (steps 1 to 8) repeated for the adjusted Y plane (with only 3 being shown in FIG. 2 for simplicity). The printing of that layer pass employing the print delivery resolution thickness; is completed when the incremented Y plane reaches the maximal Y plane 6.
10. Repeated layer passes (steps 1 to 9) are performed if required where the specified model layer rectangular construct(s) thicknesses exceed the delivery resolution thickness in order to complete the model layer print.

To print the next/subsequent model layer(s), the control software maintains a record of layers already printed and adjusts its base/floor Z component for the next layer to be printed; to be based on the maximum/highest Z positional coordinate value of the layer just printed.

FIG. 3 depicts an enlarged top view of diamond construct 30 formed of 4 rectangular primitives 30A,30B,30C and 30D in the form of trapezoids; each rectangular primitive having dimensions of length 1.0 mm; thickness of 0.2 mm.

FIG. 4 depicts a zoomed rotated view of diamond construct 30 shown in FIG. 3, formed from the four rectangular primitives; each rectangular primitive having dimensions of length 1.0 mm; thickness of 0.2 mm

FIG. 5 is a print of data contained in a GRAPE model data file required to define the 3D model depicted in FIGS. 3 and 4. The diamond construct is defined by 4 rectangular entities and each line of data in the file defines one of these rectangular entities. In keeping with the rectangular entity of FIG. 1 having data for the four corners labelled in FIG. 1 as 00, 01, 02, 03 (rectangle corners) and rectangle thickness 04, in the data file of FIG. 5, each line of code represents a coordinate in X and Y for the top corners of the four primitives of the construct shown in FIGS. 3 and 4 and the data columns are referenced for convenience as 00, 01, 02 and 03 to show those coordinates. Column 04 is the common Z coordinate and column 05 is a layer identification, in this case layer 0 for all primitives. In practice more lines of coordinates will be included for more primitives and/or print layers as required.

FIG. 6 depicts a diamond model 60 assembled from different square entity layers similar to those shown in FIG. 4. Each square entity layer made up of rectangular entities having a common thickness of 0.2 mm; with first layer rectangle length of 0.2 mm with subsequent layers 0.3, 0.4, 0.5, 0.6, 0.7, 0.8, 0.9, 1.0, 0.9, 0.8, 0.7, 0.6, 0.5, 0.4, 0.3, 0.2 mm

FIGS. 7,8 & 9 depict the file containing GRAPE data that defines the model depicted in FIG. 6. The data files follow the same line and column format as that shown in FIG. 5, i.e., X and Y coordinate data for each primitive is defined in each data line, as well as a common Z coordinate. It will be noted that the last column represents a layer identification, so that the control software can determine in what order the primitive shapes should be printed.

This GRAPE data format enables models to be defined by data files of the order of 40 times smaller than the corresponding STL files. FIG. 10 shows directory listing of the diamond model FIG. 6 outputted from the modelling software in both STL and GRAPE data formats; demonstrating that GRAPE data format is of the order of 40 times leaner that STL data format.

It will be apparent to the skilled addressee that various additions, omissions, or modifications to the examples given above will be possible without departing from the scope of the invention defined by the claims. Whilst rectangular polygonal primitives have been used in the above examples, triangular or multisided polygons could be used as forms, with the drawback that the more sides that are used, the more data will be generated. Cartesian coordinates have been used above but other coordinate systems could be used, for example radially defined coordinates could be used. The shapes and sizes of the example are merely illustrative of the invention, and any polygonal shape could be used to define the primitive forms from which that GRAPE data sets are compiled.

The 3D printing control software mentioned above has particular advantages when used to manufacture precision parts such as in bioprinting, where the printed materials such as cell structures, cell supports or scaffolds need to be arranged with great accuracy, or in an highly repeatable pattern for batch to batch experimental consistency. The inventors have found that the printed material dispensing technique also has a significant influence on print accuracy/repeatability. For that reason, they devised additional control software that allows the selection of the print dispensing technique. The invention extends to the improved printing technique now described herein. Further the range of materials that are employed in 3D printing are diverse, especially in the bioprinting field and so an adaptable printing technique is required. Materials such as self-assembling polymers, such as one or more of: collagen types 1 to 28, jellyfish collagen, nascent protein polypeptides, deoxyribonucleic acids (DNA) or ribonucleic acids (RNA), gelatin, alginate, or thermo-responsive hydrogels, or like materials require careful deposition when printing.

One technique, or first mode, dispenses a continuous stream of print material which is generally a conventional technique, but in the case of bioprinting where low viscosity materials having a kinematic viscosity of around 0.1-300 mm²/sec are used, the dispensing is a spray of material, pumped out of a small nozzle, for example a needle of about 0.05 mm to about 1 mm internal diameter (34 to 17 needle gauge). That material can be self-assembling, for example a hydrogel, to provide, after a very short time, a self-supporting structure on which to print another layer, in the same way that other materials cool and set or cure after dispensing. The velocity of the nozzle relative to the previously printed material can be adjusted to suit the time it takes for the material to self-assemble, at least to a degree sufficient to hold together once the print nozzle moves on. Control software can calculate a time period for spraying material dependent on the length of the primitive being printed and the printer nozzle speed. The start and end of the dispensing can be controlled via a simple on/off valve.

Another technique, or second mode, deals with materials that are more viscous, or at the upper end of the range of viscosity mentioned above, and so do not flow particularly easily compared to the low viscosity materials mentioned above, i.e., those with a kinematic viscosity of around 100-5000 mm²/sec. Here, the printable material tends to form a droplet comparatively slowly. In that case, the control software can be used to select a technique whereby the print nozzle, again possibly a needle at the larger end of the range of inner diameters mentioned above, pauses at a first location, allows a first droplet to form of a sufficient size that it touches the underlying material (or printer bed layer if it is the first layer to be printed), i.e. it becomes grounded, and once that grounding occurs, the nozzle moves on to a second location, adjacent the first location, to dispense another, second droplet, the first droplet having been left behind at the first location, held in place by the surface tension created as that first droplet touches its surroundings and starts its self-assembling, if such materials are used. Whilst it is envisaged that the nozzle pause time will be selectable in software, it is possible that a change in impedance, or other electrical characteristic between the print bed and the nozzle, as said touching/grounding occurs, could trigger the nozzle to move on to the next location.

In the second mode the software deposits droplets defined by the resolution of the dispensing nozzle. Beginning at the initial intersection of the primitive rectangle a droplet is dispensed and then the control software moves the needle in the x and/or y direction by, for example, the nozzle internal diameter width and then deposits another droplet and so on until the model primitive rectangle exit intersection is encountered and deposition stops. The procedure can be repeated for the next adjacent primitive until the model layer is complete. Then another layer (at a new Z value) is printed in the same manner.

The droplet dispense control is achieved by first determining the minimum pressure of the pump that can push out material from the nozzle. The control software enables the user to determine this for a material through setup configuration, or by monitoring the change in impedance mentioned above in a setup mode. The software then enables a configurable time to be specified for the pump-on time (in multiples of 10 microseconds) to achieve a single droplet to be dispensed. Using a low inertia pump such as the one mentioned below means that as the pump is switched off, or to a level where dispensing stops, it stops material flow almost immediately and thereby instantly stops material deposition from the nozzle.

The software enables a height offset of the needle above the bed of a printing machine, or previously printed part to be configured to aid droplet deposition. Typically, the height for the first mode will be around +0.01 to 2.00 mm above the print surface, with the second mode requiring around 0.5 to 2 mm range to accommodate the droplet formation.

The software also allows the user to configure a time delay (in milliseconds) before moving the needle position from its just deposited position to the next deposition position to again aid print accuracy and reliability, for example to enable material self-setting time.

The preferred method of providing flow for dispensing printing materials is the use of a piezoelectric pump which provides a piezo-vibratory element in a flow path to change locally the flow path's volume, and two one-way valves arranged in a flow path, one each side of the piezoelectric vibratory element. Such a pump is commercially available from TTP Ventus Ltd as a HP series pump, although it is not intended for the use described herein. That pump is electronically controllable to provide a substantially infinitely variable output from zero to 100% of the rated output, up to 600 mBar in this case, or up to 150 ml litres per minute at lower pressures, by means of controlling the voltage of an ac waveform driver. The almost non-existent pulsation output has been found to provide a smooth and consistent dispensing for printing, and the controllable nature of the pump allows fine adjustment to suit the material being dispensed. It has been found that the pump can be operated at a set point, i.e., a voltage which provides reliable dispensing of the material to be printed, but need not be switched completely off when no dispensing is required, rather a low voltage set point can be used as the ‘off’ setting. This low voltage setting means the dispensing can be initiated again almost instantaneously when needed, without having to wait for the pump pressure to build up again. The preferred arrangement of the pump is to provide a closed vial or vessel of printable material with a gas head space (e.g. filtered air or an inert gas), the head space being pressurised by the pump such that the material can exit the vessel via a flow path to the print head nozzle. The pressure within the vessel can be maintained via a PID controller with the PID coefficients selectable from a look-up table or customisable, to suit the material being printed, the speed of printing required and the volume of printing (nozzle size). A fast acting on/off valve can be employed, in the path although with PID control, or similar, of the pressure in the head space, the valve could be omitted.

FIG. 11 shows schematically an example of the hardware required for the printing techniques described above. A 3D printer 10 includes a controller 20, which will accept print instructions, for example the GRAPE instructions mentioned above. The controller in use will control a print head 30 to cause movement of the head in X,Y and Z directions relative to a printer bed 12. The controller will also control a piezoelectric pump 40 of the type described above, and a control valve 32 to stop or inhibit fluid flow to a dispensing nozzle 34, in this case a hollow needle.

In use the hardware will function as described above, where the controller will control the pump according to a PID algorithm to maintain pressure and the coefficients for the PID algorithm are selectable for different print materials. The pump has a filtered air inlet 42 and is in fluid communication with a print material vial 50 via a pump outlet 44. The vial 50 has a cap 52 sealed around the vial body to provide a sealed head space 54. When pressurised air is fed to the head space from the pump 40 the headspace too will become pressurised. The pressure in the headspace will be controlled such that it is sufficient to force print material P in the vial into a vial outlet 56 and into the printhead 30. From there, when the valve 32 is open, the print material P is forced into the printing nozzle 34.

The pressure induced by the pump 40, and the size of the nozzle 34 are selectable to suit the material P being printed. Generally, that selection will be influenced by the kinematic viscosity of the material P. As mentioned above, in a first mode of printing, having a constant jet of generally low viscosity material, the control valve 32 will be used to start and stop dispensing, or in a second mode including stepwise droplet type deposition of the material where the material has higher viscosity, the valve 32 need not be used. Shown in the drawing is a droplet D forming as the material slowly extrudes from the nozzle 34 with the printhead dwelling in a generally stationary position (second mode of printing). Once the droplet is grounded the printhead can move on and leave the droplet D behind. The parameters of the controller 20 associated with the dwell time during droplet deposition can be adjusted to suit the material parameters.

FIG. 12 depicts the plain view of a disc of radius 6.2 mm and thickness 0.2 mm and selected arc angle of 10° for drawing the disc circle. The disc is divided by into rectangles in the manner described above, i.e. using the GRAPE format.

FIG. 13 is a screen capture of the model data generated to define the disc as shown in FIG. 12.

FIG. 14 is a computer-generated file listing showing the model data file sizes for the disc shown in FIG. 12, when defined in both GRAPE and conventional STL.

FIG. 15 depicts the plain view of an annulus of radius 6.2 mm and thickness 0.2 mm and selected arc angle of 10° for drawing the circle.

FIG. 16 is a screen capture of the model data generated in the GRAPE format to the annulus shown in FIG. 15.

FIG. 17 depicts the plain view of an inverse annulus (a ring shaped void) contained within a square model construct; with radius 6.2 mm and thickness 0.2 mm and selected arc angle of 10° for defining the ring shaped void; and the containment square extending the void min X/Y and max X/Y void coordinates by 1.0 mm.

FIG. 18 is a screen capture of the model data generated to define the square with its void as shown in FIG. 17.

FIG. 19 is a computer-generated file listing showing the data file sizes for the model of FIG. 17 when defined in both GRAPE and STL formats.

Note that the resolution of the drawn/defined circle models can be improved by reducing the arc angle and thickness employed; and these being just examples.

The control software utilises two additional Extensible Markup Language (xml) data files to:
1. define the model layers to be printed referred to as a ‘Recipe’ (an example being given in FIGS. 20); and
2. define material specific parameters referred to as ‘Material Deliveries’ (an example being given in FIG. 21) to effect optimal printing of the model layer.

FIG. 20 is a computer generated Extensible Markup Language (xml) recipe file describing a model to be printed. The recipe has 5 steps:
1. Charging step to ensure that the material ‘An Innovative Bioink’ is fully deployed from the material vial to the print head nozzle (pre-print transport path); prior to printing the model layers. There is no model file applicable to this recipe step and has been further identified as a ‘Charge’ function.
2. Recipe proceeds with 3 model layers to be printed; each layer being a disc as identified by the referenced GRAPE model file ‘C:/tests/Disc.cbl’; to be printed with ‘An Innovative Bioink’ material with each step further identified as a model ‘File’ function.
3. Recipe completes with a cleaning step in which a clean material ‘Alcohol Based Cleaner’ is utilised to flush out the pre-print transport path. There is no model file applicable to this recipe step and has been further identified as a ‘Clean’ function.

Control software enables operators to create/edit/save recipe files in order to effect the 3D printing of a model in a layer by layer fashion.

This recipe file is utilised by the control software to effect a 3D model printing process; as it dictates the steps to be followed. The control software further utilises the ‘Material Deliveries’ xml file as described below to obtain layer/step specific optimal printing/deployment parameters for the material(s) associated with each of the step(s); for example charging and cleaning pressures and times; printing dispense on/off pressures and printer head X direction travel speed.

FIG. 21 is a computer generated Extensible Markup Language (xml) ‘Material Deliveries’ file describing the optimal parameters for the printing/deployment of specific materials. The control software enables operators to create/delete/edit material delivery configurations and these actions are applied to and material configurations maintained in the ‘Material Deliveries’ xml file.

Each material delivery configuration defines:
1. Material model or cleaner as defined by ‘Cleaner’ field ‘Yes’ signifies ‘Cleaner’ as in the case for ‘Alcohol Based Cleaner’; and ‘No’ signifies ‘Model’ as in the case for ‘An Innovative Bioink’ for example.
2. ‘SetValueCharge’ field defines the pressure in mBar to be employed by the control software as a set point pump pressure; when a recipe step requires this material to be used to clean or charge the pre-print transport path. For example 500 mBar has been configured for ‘An Innovative Bioink’.
3. ‘SetValueDispenseOn’ field defines the pressure in mBar to be employed by the control software as a set point pump pressure; when a recipe step requires this material to be dispensed at each model layer print coordinate. For example 50 mBar has been configured for ‘An Innovative Bioink’
4. ‘SetValueDispenseOff’ field defines the pressure in mBar to be employed by the control software as a set point pump pressure; when a recipe step requires this material to not be dispensed whilst the print head moves between each model layer print coordinate. For example 40 mBar has been configured for ‘An Innovative Bioink’
5. ‘ProportionalCoeff’ field utilised by the control software for performing proportional-integral-derivative closed loop control of the pump pressure set points for this material. For example 100 proportional weighting has been configured for ‘An Innovative Bioink’
6. ‘IntegralCoeff’ field utilised by the control software for performing proportional-integral-derivative closed loop control of the pump pressure set points for this material. For example 50 integral weighting has been configured for ‘An Innovative Bioink’
7. ‘DifferentialCoeff’ field utilised by the control software for performing proportional-integral-derivative closed loop control of the pump pressure set points for this material. For example 0 differential weighting has been configured for ‘An Innovative Bioink’
8. ‘Speed’ field is utilised by the control software for adjusting the speed in mm/s of the printer head ‘X’ direction movement for this material. For example 50 mm/s has been configured for ‘An Innovative Bioink’. This field enables optimal printing performance for a material.
9. ‘BedTemp’ field is utilised by the control software for adjusting the printer bed temperature; in which the material will encounter post-print. For example 20° C. has been configured for ‘An Innovative Bioink’. This field enables optimal printing performance for a material.
10. ‘CubeTemp’ field is utilised by the control software for adjusting the printer internal enclosure temperature; in which the material will encounter during the pre-print transport path. For example 50° C. has been configured for ‘An Innovative Bioink’. This field enables optimal printing performance for a material.
11. ‘PumpDroplet’ field is utilised by the control software for selecting how long the ‘DispensePumpOn’ pressure will be applied at each model layer print coordinate in units of ×10 μS. For example 10000×10 μS has been configured for ‘An Innovative Bioink’. This field enables optimal printing performance for a material.
12. ‘NozzleHgt’ field is utilised by the control software for selecting a base offset height for the nozzle above the printer bed in mm. This base offset height if configured is applied to all model layer print coordinates and allows for plates (e.g. petri dish) of varying thicknesses to be placed on the printer bed in order for the model to be printed onto. For example 0.2 mm has been configured for ‘An Innovative Bioink’.
13. ‘PumpOnCharge’ field is utilised by the control software for selecting a duration that the pump will be switched on in units of mS; whilst performing a ‘Clean’ or ‘Charge’ step as appropriate for the material configuration. For example 2000 mS has been configured for ‘An Innovative Bioink’.
14. ‘NozzleRes’ field is utilised by the control software for printing the model layer and defines the nozzle resolution in mm. The lower the nozzle resolution the more accurate the control software can positionally achieve the model layer print coordinates. For example 0.2 mm has been configured for ‘An Innovative Bioink’. This field enables optimal printing performance for a material.
15. ‘NozzleDelay’ field is utilised by the control software for printing the model layer and defines the nozzle wait time in mS before moving off a model layer print coordinate. This parameter enables a pause before moving off model layer print coordinates; to aid material deposition. For example 100 mS has been configured for ‘An Innovative Bioink’. This field enables optimal printing performance for a material.
16. ‘NozzleClearance’ field is utilised by the control software for printing the model layer and defines the nozzle move height in mm. This feature enables operators to be able to print model layer constructs into say a 24 well plate; as the nozzle height is adjusted to an elevated position prior to moving to the next model layer print coordinates. For example 0.4 mm has been configured for ‘An Innovative Bioink’ to aid deposition of a material droplet. This field enables optimal printing performance for a material.

Examples of the implementation of the invention have been provided above but it will be apparent to the skilled addressee that various modifications, additions, and omissions could be implemented without departing from the essence of the invention. Features defined in combination could where applicable be separated, and features defined separately could be combined, all without adding matter.

1. A method for preparing a data set for a construct to be printed in layers, the method comprising using a computer program to carry out the steps of:
a) defining in a two-dimensional plane a layer of the construct in terms of one or more polygonal primitives;
b) for each primitive defining first and second coordinates in the two dimensions representing corner points of the or each primitive;
c) defining a common third coordinate based on the thickness of the or each primitive perpendicular to the two-dimensional plane; and
d) forming a data set based on the first second and third coordinates.

2. A method according to claim 1 including the further step of defining additional multiple layers of the construct according to further data sets, whereby the additional layers are layers printable substantially on top of preceding layers and the additional layers are identified in the data set.

3. A method according to claim 1 wherein the or each polygonal primitive is a four sided polygon and each data set includes four corner point coordinates.

4. A method according to claim 1 wherein, the two-dimensional plane is an X and Y cartesian plane corresponding to the flat bed printing plane of a conventional 3D printer, and the thickness is a dimension in the Z plane corresponding to the height above the flat printing bed.

5. A method according to claim 1, including the additional steps of providing printer control software which accepts the data set and wherein the control software performs a slicing step, incrementally slicing the or each primitive perpendicular to one of the two dimensions multiple times, and thereby defining a print start point and a print end point along each slice for the or each primitive.

6. A method according to claim 5, wherein the two-dimensional plane is an X and Y cartesian plane corresponding to the flat bed printing plane of a conventional 3D printer, and the thickness is a dimension in the Z plane corresponding to the height above the flat printing bed, and the slicing is performed in the Z plane and said increments are steps in the X or Y directions.

7. The method according to claim 5, the method further including providing a 3D printer including a print head and a controller arranged to move the print head according to instructions derived from the printer control software.

8. The method as claimed in claim 7 wherein said controller accepts said instructions as a print file for each layer to be printed, for example a .cbl file

9. The method as claimed in claim 7 further including providing a print material charging pump, a print nozzle, and a printer bed wherein said controller accepts further instructions as a separate file or files, for example a .xml file(s), said further instructions including at least one of:
a) printer nozzle cleaning instructions;
b) pump charging pressure instructions;
c) nozzle pressure while printing instructions;
d) nozzle pressure while not printing instructions;
e) pump pressure PID parameters;
f) print head travel speed relative to print bed;
g) print bed temperature during printing;
h) printer enclosure temperature;
i) print material droplet size (pump time on) instructions.
j) nozzle height above print layer;
k) pump run duration during charging or cleaning;
l) nozzle opening size selection;
m) nozzle/print head dwell time;
n) nozzle lift height between printing steps;
o) print material preparation instructions;
p) progress with get print file instructions;
q) post print cleaning instructions; and
r) post print printer bed temperature instructions.

10. The method as claimed in claim 8, wherein the controller controls the print head to dispense material in a selectable manner, the selection including first printing mode wherein continuous dispensing of material occurs while the print head moves and a second printing mode wherein dispensing of the material while the print head is stationary occurs and wherein the print head moves step wise to one or more further dispensing locations and repeats the stationary dispensing.

11. (canceled)

12. The method claimed in claim 1 further including a 3D printing technique comprising:
a) controlling a print material dispensing part such that it is substantially stationary at a first location, b) dispensing the print material in the form of a droplet at the first location;
c) moving the dispensing part to a second location relative to a bed, only once the droplet dispensed at the first location touches either a bed of a printing machine or a previously printed feature; and
d) optionally dispensing a further droplet of material at the second location.

13. The method claimed in claim 1 further comprising a 3D printing technique comprising selectable printing modes, wherein in a first of said modes:
i) a print head is moved relative to a printer bed while continually dispensing print material;
and in a second of the modes:
ii) the print head is stationary at a first location while dispensing print material;
iii) then the print head stops dispensing once the material touches previously dispensed material or the printer bed;
iv) then the print head moves relative the printer bed to a second location and then the print head further dispenses print material at the second location.

14. A 3D printing technique according to claim 13, wherein the second mode includes repeating the steps ii), iii) and iv) in that order.

15. A 3D printer arranged to selectively print materials having a range of kinematic viscosity from about 0.1 mm²/sec to about 5000 mm²/sec, the printer including a print material storage vessel and a print head nozzle for dispensing the materials in fluid communication with the storage vessel via fluid path, fluid flow from the vessel to the nozzle via the fluid path being induced by a pump which pressurises in use the vessel.

16. A 3D printer as claimed in claim 15, wherein the pump includes a piezoelectric element for inducing said pressurisation, and optionally a closable valve is included to interrupt the fluid path.

17. A 3D printing technique for comprising utilising a printer instruction file defining a path for a printer nozzle, and utilising a further printer recipe file and a further material delivery file to provide at least one of:
a) printer nozzle cleaning instructions;
b) pump charging pressure instructions;
c) nozzle pressure while printing instructions;
d) nozzle pressure while not printing instructions;
e) pump pressure PID parameters;
f) print head travel speed relative to print bed;
g) print bed temperature during printing;
h) printer enclosure temperature;
i) print material droplet size (pump time on) instructions.
j) nozzle height above print layer;
k) pump run duration during charging or cleaning;
l) nozzle opening size selection;
m) nozzle/print head dwell time;
n) nozzle lift height between printing steps;
o) print material preparation instructions;
p) progress with get print file instructions;
q) post print cleaning instructions; and
r) post print printer bed temperature instructions.
